(19) United States
(12) Patent Application Publication
(10) Pub. No.: US 2011/0158531 A1
(43) Pub. Date: Jun. 30, 2011

(54) IMAGE PROCESSING APPARATUS AND CONTROL METHOD THEREOF

(75) Inventor: Ken Achiwa, Kawasaki-shi (JP)

(73) Assignee: CANON KABUSHIKI KAISHA, Tokyo (JP)

(21) Appl. No.: 12/958,047

(22) Filed: Dec. 1, 2010

(30) Foreign Application Priority Data
Dec. 25, 2009 (JP) 2009-296373

(51) Int. Cl. G06K 9/34

(52) U.S. Cl. 382/173

(57) ABSTRACT

An image processing apparatus divides inputted image data into blocks of a predetermined size, applies a plurality of image processes to each block, and determines whether a block includes image data with an attribute of not executing predetermined image processes. As a result of the determination, the predetermined image processes are not applied to the block if it is determined that the block includes the image data with the attribute of not executing the predetermined image processes. However, the predetermined image processes are applied to the block if it is determined that the block does not include the image data with the attribute of not executing the predetermined image processes. The image data with the attribute of not executing the predetermined image processes is vector image data, and the predetermined image processes are rendering, resolution conversion, and image compression.

### BACKGROUND OF THE INVENTION

1. Field of the Invention

The present invention relates to a technique of outputting raster image data after converting the resolution.

2. Description of the Related Art

Conventionally, an image processing apparatus that reduces raster image data by resolution conversion and that compresses the reduced image data is disclosed (for example, see Japanese Patent Laid-Open No. 2007-281591). The apparatus first calculates the enlargement ratio or the reduction ratio for converting raster image data in the rendering objects included in a PDL into output resolution. Secondly, the apparatus evaluates whether a process of lowering the effective resolution of the raster image data is required to attain a predetermined compression ratio by image compression in a latter stage. Thirdly, if it is evaluated that the process of lowering the effective resolution of the raster image data is required, the apparatus simultaneously executes a process of lowering the effective resolution when the data is enlarged or reduced by resolution conversion.

According to the conventional technique, the degradation of image quality can be prevented by making a change to execute the resolution conversion immediately, when the resolution conversion needs to be repeated for the raster image data included in the PDL.

However, although the degradation of image quality of the raster image data included in the PDL can be prevented in the conventional technique, the throughput of image processing for the PDL cannot be improved. Particularly, the degradation of image quality of the block-by-block raster image data included in the PDL can be prevented when image processing is executed block by block. However, the throughput of the block-by-block image processing for the PDL cannot be improved.

### SUMMARY OF THE INVENTION

The present invention provides an apparatus and a method with improved throughput of image processing when a plurality of image processes are executed block by block.

According to one aspect of the present invention, there is provided an image processing apparatus that divides inputted image data into blocks of a predetermined size and that applies a plurality of image processes to each block, the apparatus comprising: a determination unit that determines whether a block includes image data with an attribute of not executing predetermined image processes when the plurality of image processes are executed; and a control unit that does not apply the predetermined image processes to the block if the determination unit determines that the block includes the image data with the attribute of not executing the predetermined image processes and that applies the predetermined image processes to the block if the determination unit determines that the block does not include the image data with the attribute of not executing the predetermined image processes, wherein the image data with the attribute of not executing the predetermined image processes is vector image data, and the predetermined image processes are rendering, resolution conversion, and image compression.

Further features of the present invention will become apparent from the following description of exemplary embodiments (with reference to the attached drawings).

### BRIEF DESCRIPTION OF THE DRAWINGS

FIG. 1 is a diagram showing a network configuration of an image processing apparatus according to the present embodiment.

FIG. 2 is a diagram showing a block configuration of an image processing apparatus 100 shown in FIG. 1.

FIG. 3 is a flow chart showing a PDL process of the image processing apparatus according to the present embodiment.

FIG. 4 is a flow chart showing a printing process of the image processing apparatus according to the present embodiment.

FIG. 5 is a flow chart showing a PDL extension process (S102) shown in FIG. 3.

FIG. 6 is a flow chart showing a rendering process (S103) shown in FIG. 3.

FIG. 7 is a flow chart showing a resolution conversion (reduction) process (S104) shown in FIG. 3.

FIG. 8 is a flow chart showing an image compression process (S105) shown in FIG. 3.

FIG. 9 is a diagram showing a block-by-block image processing determination method of the image processing apparatus according to the present embodiment.

FIG. 10A is a conceptual diagram showing page image data according to the present embodiment, and FIG. 10B is a conceptual diagram showing page attribute data according to the present embodiment.

FIG. 11A is a diagram showing an example of packet data in data processing before spooling corresponding to FIGS. 10A and 10B, and FIG. 11B is a diagram showing a data flow of the data processing before spooling according to the present embodiment.

FIG. 12A is a diagram showing an example of packet data in data processing after spooling corresponding to FIGS. 10A and 108, and FIG. 12B is a diagram showing a data flow of the data processing after spooling according to the present embodiment.

### DESCRIPTION OF THE EMBODIMENTS

Hereinafter, an embodiment for carrying out the invention will be described in detail with reference to the drawings. In the present embodiment, a multi-function peripheral (MFP) that can simultaneously realize a plurality of different functions, such as a copy function, a print function, a scan function, and a FAX function, will be described as an example of an image processing apparatus.

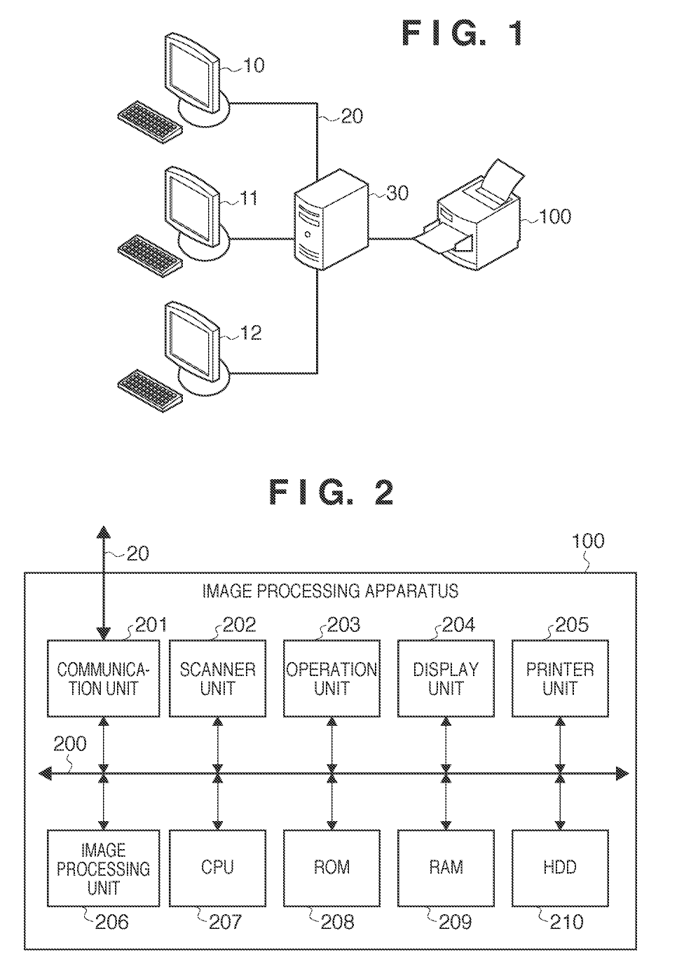

A network configuration of the image processing apparatus according to the present embodiment will be described first with reference to FIG. 1. As shown in FIG. 1, a single image processing apparatus 100 and a plurality of network terminals 10 to 12 are connected to a network server 30 through a network 20. This realizes a network configuration in which the plurality of network terminals 10 to 12 share the single image processing apparatus 100. The numbers of the apparatuses in the network configuration shown in FIG. 1 are examples, and the present invention does not limit the numbers of connectable apparatuses to these.

The image processing apparatus 100 applies a PDL process to a PDL received from one of the plurality of network terminals 10 to 12 through the network 20 and prints raster image data obtained in the PDL process on recording paper. More specifically, the image processing apparatus 100 provides a printed matter, on which the raster image data obtained by developing the PDL is printed, to a user who has requested the PDL process from one of the plurality of network terminals 10 to 12.

Each of the network terminals 10 to 12 is a computer, such as a personal computer, including a printer driver that creates print data when printing is performed from an application and that transmits the print data to the image processing apparatus 100 and including a network connection function.

A block configuration of the image processing apparatus 100 shown in FIG. 1 will be described with reference to FIG. 2. As shown in FIG. 2, the image processing apparatus 100 realizes the network configuration shown in FIG. 1 by a communication unit 201 connecting to the network 20. The image processing apparatus 100 has a configuration in which processing units, such as the communication unit 201 and a printer unit 205, are electrically connected through an internal bus 200.

The communication unit 201 is a processing unit that transmits and receives data to and from external devices. The communication unit 201 connects to the network 20, such as the Internet and a LAN, to transmit and receive data to and from external devices. The communication unit 201 also connects to a public telephone line to perform FAX communication and directly connects to a USB memory device to perform data communication.

A scanner unit 202 is a processing unit that optically reads a document image to output the signal after converting the image to an electrical image signal. The scanner unit 202 is constituted by a contact type image sensor, a reading drive unit, a reading lighting control unit, etc. In the scanner unit 202, the reading lighting control unit controls lighting of the LED in the contact type image sensor conveyed by the reading drive unit when the contact type image sensor scans the entire document. At the same time, in the scanner unit 202, a photo sensor in the contact type image sensor optically reads the document image to output the image after converting the image to an electrical image signal.

An operation unit 203 is a processing unit that receives an instruction from the user as input. The operation unit 203 is realized by, for example, hardware keys or a touch panel and is also a user interface that receives a key operation from the user related to a process executed by the image processing apparatus 100 as input.

A display unit 204 is a processing unit that displays the state of the image processing apparatus 100 as output for the user. The display unit 204 is realized by, for example, a liquid crystal panel or a liquid crystal touch panel with a function of the operation unit 203. The display unit 204 provides a user interface that displays information, such as settings related to a process executed by the image processing apparatus 100 and processing results.

A printer unit 205 is a processing unit that prints the electrical image signal temporarily stored in the image processing apparatus 100 to recording paper as a visible image. The printer unit 205 is realized by, for example, a laser beam printer or an inkjet printer. The printer unit 205 prints the raster image data temporarily stored in the image processing apparatus 100 on prepared recording paper based on output resolution.

An image processing unit 206 is a processing unit that applies scanning image processing, printing image processing, communication image processing, etc. to the image data in the image processing apparatus 100. The image processing unit 206 applies image processing suitable for scan device characteristics, such as shading correction, gamma processing, binarization processing, halftone processing, and color space conversion from RGB to CMYK, to image data received from the scanner unit 202 during scanning. The image processing unit 206 also applies image processing suitable for printer device characteristics, such as resolution conversion, smoothing, and density correction, to image data stored in an HOD 210, etc. during printing. The image processing unit 206 further applies image processing suitable for communication device characteristics, such as resolution conversion and color space conversion, to image data transferred through the communication unit 201 during communication.

A CPU 207 is a processing unit that transfers image data between processing units of the image processing apparatus 100 and that applies image processing to image data. The CPU 207 sequentially executes programs stored in a ROM 208 or a RAM 209 described later to control transfer of image data and to execute image processing.

The ROM 208 is a storage unit that holds programs describing control procedures of image data handling and image processing executed by the image processing apparatus 100. The RAM 209 and the hard disk HDD 210 are storage units that temporarily hold the programs describing the control procedures of the image processing apparatus 100 and the image data.

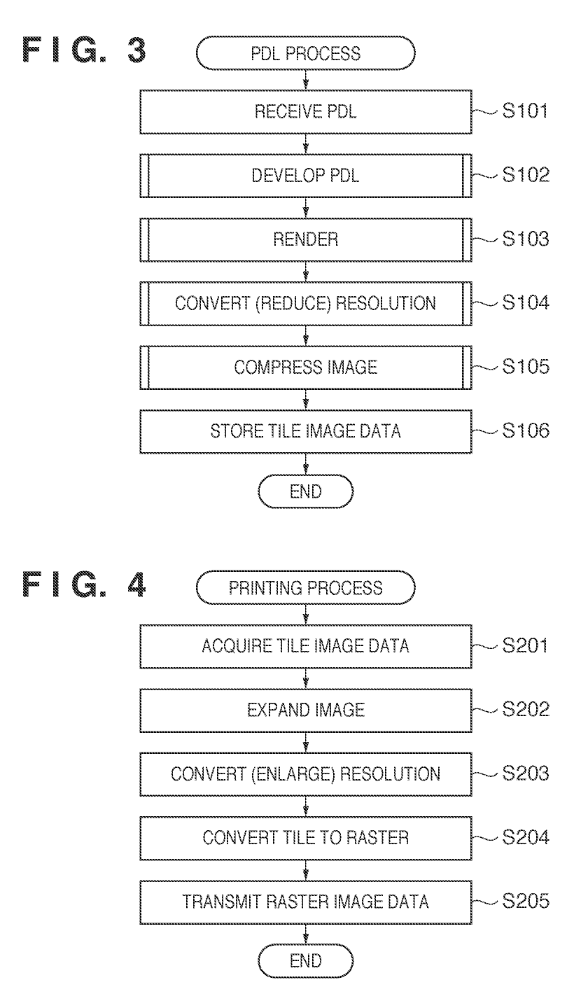

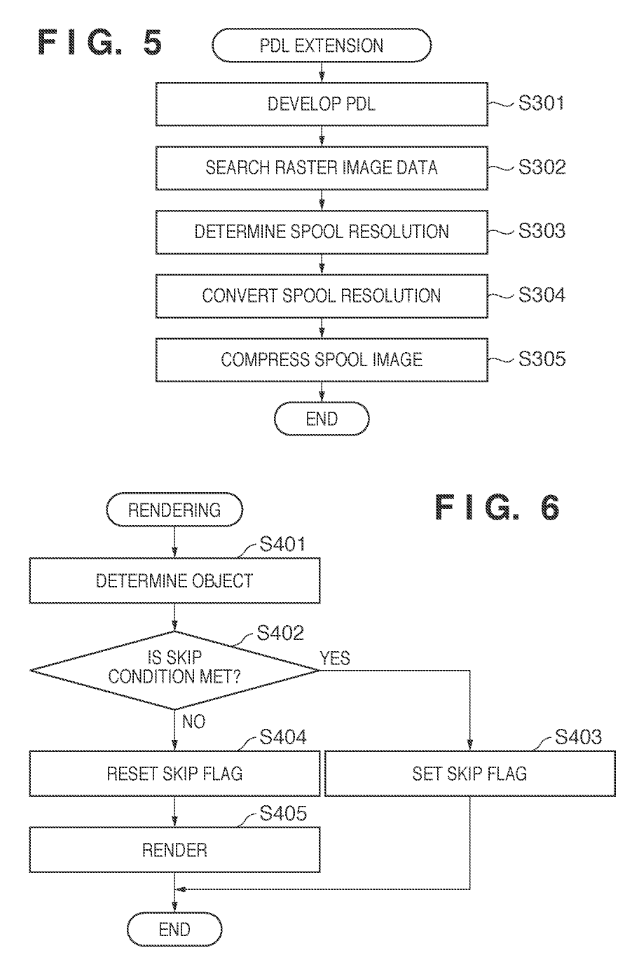

Based on the configuration, a PDL process of the image processing apparatus 100 according to the present embodiment will be described with reference to FIG. 3. The communication unit 201 receives the PDL transferred from the network terminals 10 to 12 on the network 20 and temporarily stores the received PDL in the RAM 209 or the HDD 210 (S101). The image processing unit 206 develops the PDL acquired in S101 and generates a display list (S102). Details of S102 will be described with reference to FIG. 5.

The image processing unit 206 renders the display list generated in S102 and generates raster image data formed by blocks of a predetermined size (64 pixels×64 pixels) (S103). Details of S103 will be described later with reference to FIG. 6.

In the present embodiment, the entity of page image data divided into blocks will be called tile image data. The unit of data transfer including header information, image data, and attribute data of the tile image data will be called packet data.

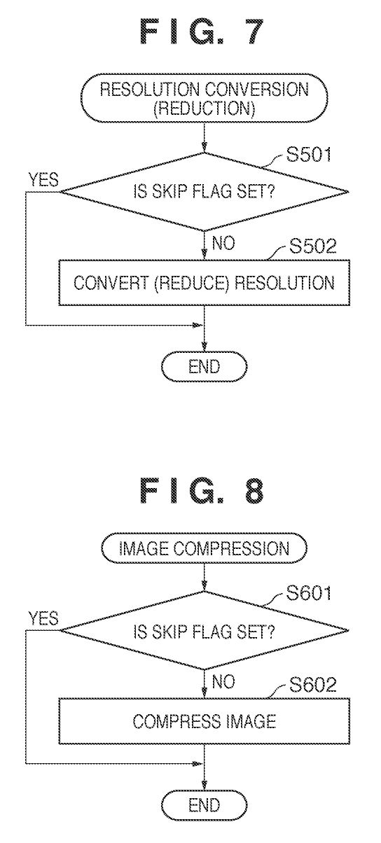

The image processing unit 206 converts the resolution of the raster image data generated in S103 to generate raster image data reduced block by block (S104). Details of S104 will be described later with reference to FIG. 7.

The image processing unit 206 compresses the reduced raster image data generated in S104 to generate raster image data compressed block by block (S103). Details of S105 will be described later with reference to FIG. 8. The image processing unit 206 stores the compressed raster image data generated in S105 in the RAM 209 or the HDD 210 (S106) to finish the process.

The printing process of the image processing apparatus 100 according to the present embodiment will be described with reference to FIG. 4. The image processing unit 206 acquires the compressed raster image data stored in S106 from the RAM 209 or the HDD 210 (S201). The image processing unit 206 expands the compressed raster image data acquired in S201 to generate raster image data reduced block by block (S202). The image processing unit 206 converts the resolution of the reduced raster image data generated in S202 to generate raster image data enlarged block by block (S203). The image processing unit 206 develops the enlarged raster image data generated in S203 to a buffer memory to generate page-by-page raster image data from the block-by-block raster image data (S204). The image processing unit 206 transmits the page-by-page raster image data generated in S204 to the printer unit 205 (S205).

The PDL extension process shown in FIG. 3 (S102) will be described with reference to FIG. 5. The image processing unit 206 develops the PDL acquired in S101 to generate a display list (S301). The rendering objects included in the generated display list are classified into two types: vector image data, such as characters and graphics; and raster image data, such as images.

The image processing unit 206 searches raster image data, such as images attached to the original PDL, from the rendering objects included in the display list generated in S301 (S302). The image processing unit 206 determines, for the raster image data searched in S302, the resolution obtained as a result when the resolution is converted (reduced) after rendering in S103 and rendering in S104 (S303). For example, it is determined that 300 dpi is the spool resolution if rendering is performed with 64 pixels×64 pixels equivalent to 600 dpi, and then the resolution is converted (reduced) to 32 pixels×32 pixels equivalent to 300 dpi.

Scaling executed in the rendering is taken into consideration in the determined resolution. Conversion processes other than scaling to the raster image data, such as rotation and mirror reflection, are applied in advance to the raster image data.

The image processing unit 206 converts the resolution of the raster image data searched in S302 to the resolution determined in S303 (S304). The image processing unit 206 uses a conventionally known compression algorithm, such as JPEG, to compress the raster image data generated in S304.

The rendering process (S103) shown in FIG. 3 will be described with reference to FIG. 6. The image processing unit 206 holds at least the rendering objects included in the tile image data in the buffer memory and determines the attributes of the rendering objects included in the tile image data (S401). In this case, the rendering objects held by the tile image data are classified into objects including only vector image data, such as characteristics and graphics, objects including only raster image data, such as images, objects including vector image data and raster image data, and objects not including vector image data and raster image data.

The image processing unit 206 refers to the attributes of the rendering objects included in the tile image data determined in S401 and determines whether the referenced attributes meet a predetermined skip condition (S402). An example of a specific determination condition includes that the rendering objects included in the tile image data do not include vector image data. If the tile image data meets the skip condition (Yes in S402), the process moves to S403. In S403, the image processing unit 206 sets a skip flag (“1”) that is part of the header information held by the packet data of the tile image data. The process then ends.

On the other hand, if the tile image data determined in S402 does not meet the skip condition, the process moves to S404. In S404, the skip flag that is part of the header information held by the packet data of the tile image data is reset (“0”). The image processing unit 206 executes a rendering process (S405) and ends the process.

The resolution conversion (reduction) process (S104) shown in FIG. 3 will be described with reference to FIG. 7. The image processing unit 206 refers to the skip flag set in S403, and if “1” is set to the skip flag (YES in S501), the resolution conversion (reduction) process is not executed, and the resolution conversion (reduction) process ends.

On the other hand, if the skip flag is reset (“0”) in S501, the process moves to S502. In S502, the image processing unit 206 executes a resolution conversion (reduction) process.

The image compression process (S105) shown in FIG. 3 will be described with reference to FIG. 8. The image processing unit 206 refers to the skip flag set in S403, and if the skip flag is set to 1 (YES in S601), the image processing unit 206 does not execute the image compression process and ends the image compression process. On the other hand, if the skip flag is reset (“0”) in S601, the process moves to S602, and the image processing unit 206 executes the image compression process.

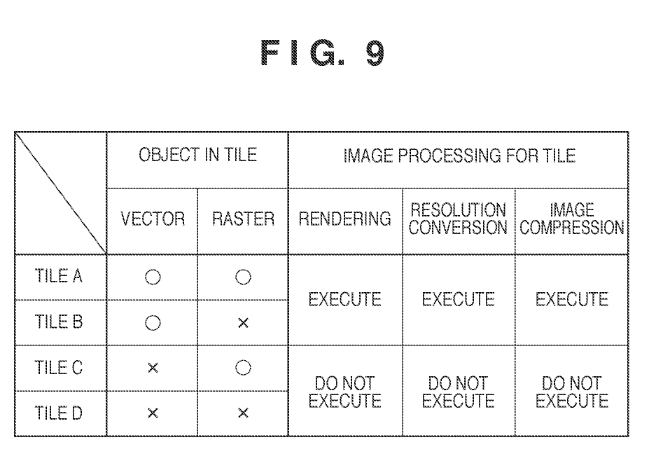

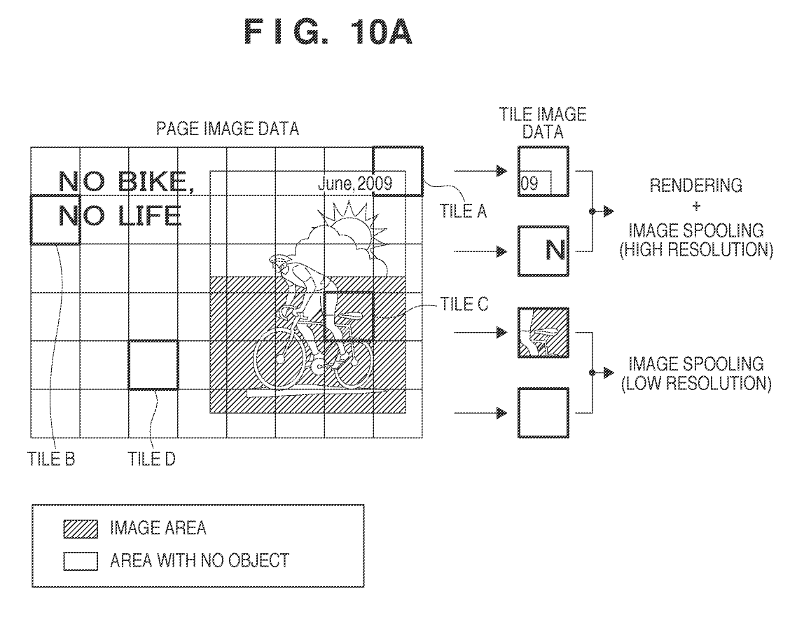

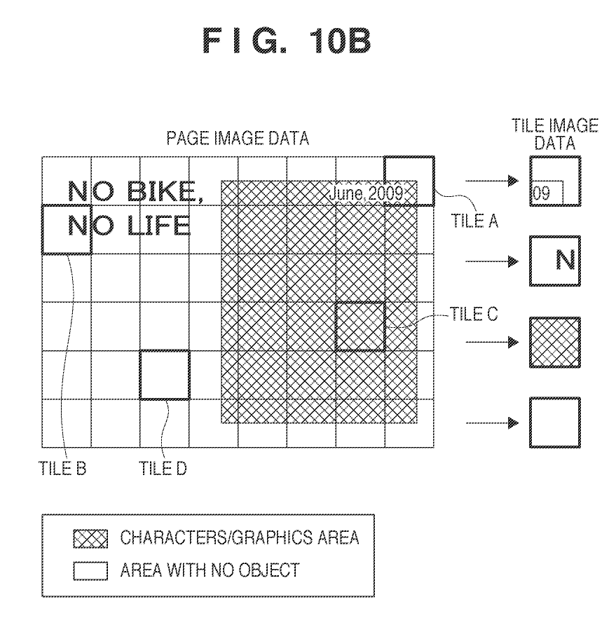

The series of processes of FIGS. 6 to 8 will be specifically described with reference to FIGS. 9 to 12. FIG. 9 is a diagram showing a block-by-block image processing determination method of the image processing apparatus 100 according to the present embodiment. FIG. 10A is a conceptual diagram showing page image data according to the present embodiment. FIG. 10B is a conceptual diagram showing page attribute data according to the present embodiment.

FIG. 9 shows a result of the classification of the tile image data A to D of FIGS. 10A and 10B into four categories described in S401 and the determination of the skip condition of S402. As shown in FIG. 9, the tile image data A and B include at least one vector image data as rendering objects. Therefore, the skip flags of the tile image data A and B are reset (“0”). On the other hand, the tile image data C and D do not include any vector image data as rendering objects. Therefore, the skip flags of the tile image data C and D are set (“1”).

More specifically, the rendering process, the resolution conversion (reduction) process, and the image compression process are applied to the tile image data A and B in which the skip flags are not set. The packet data is transferred and spooled in the RAM 209 or the HDD 210. On the other hand, the rendering process, the resolution conversion (reduction) process, and the image compression process are not applied to the tile image data C and D in which the skip flags are set. The packet data is transferred and spooled in the RAM 209 or the HDD 210.

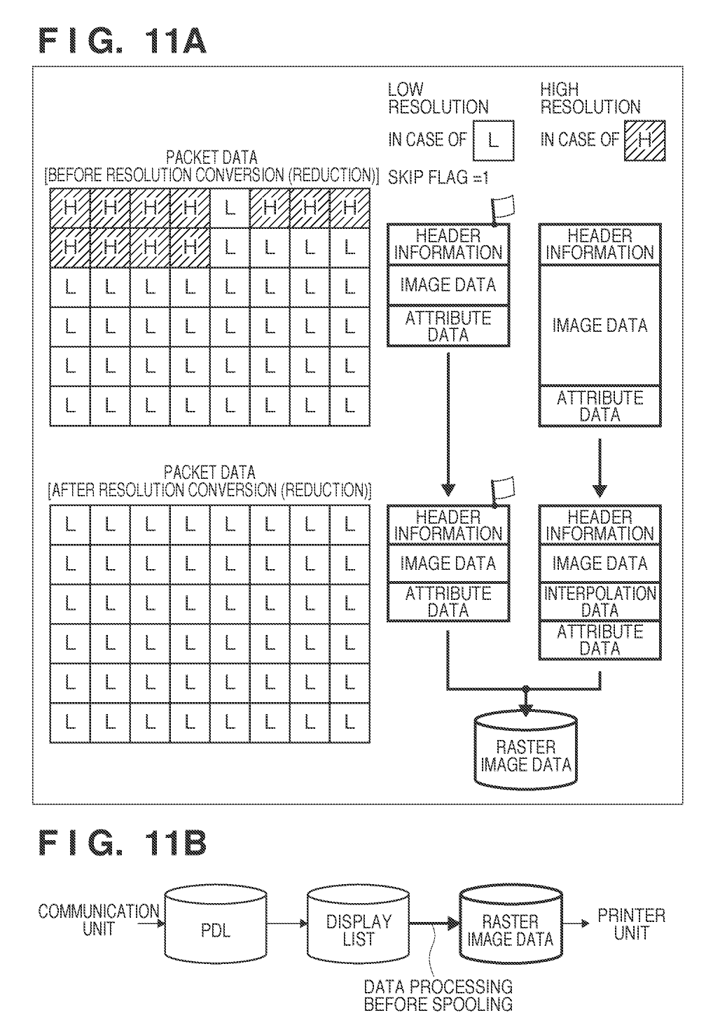

FIG. 11A is a diagram showing an example of packet data in data processing before spooling corresponding to FIGS. 10A and 10B. FIG. 11B is a diagram showing a data flow of the data processing before spooling according to the present embodiment.

As shown in FIG. 11A, a rendering process is applied at high resolution to packet data corresponding to the tile image data A and B including vector image data among the packet data shown in FIGS. 10A and 10B. As shown in FIG. 11A, the packet data applied with the rendering process at high resolution will be indicated by “H”.

Meanwhile, the original resolution is maintained for the packet data corresponding to the tile image data C and D not including vector image data among the packet data shown in FIGS. 10A and 10B. The packet data is transferred without the execution of the rendering process. Similarly, the packet data in which the original resolution is maintained and to which the rendering process is not applied will be indicated by “L” as shown in FIG. 11A.

In other words, as shown in FIG. 11B, the packet data is transferred as indicated by two arrows relative to a data flow of one line when the display list is converted to the raster image data in the data flow of the data processing before spooling. More specifically, the packet data indicated by “L” including the raster image data that is set with the skip flag and that is converted to the spool resolution in advance is spooled in the RAM 209 or the HDD 210 without the execution of the rendering, the resolution conversion (reduction), and the image compression.

On the other hand, the rendering, the resolution conversion (reduction), and the image compression are applied to the packet data indicated by “H” in which the skip flag is reset, and the packet data is spooled in the RAM 209 or the HDD 210. As a result, not only the degradation of image quality of the raster image data can be prevented, but also the throughput of the block-by-block image processing for the packet data can be improved.

In FIG. 11A, “INTERPOLATION DATA” denotes data obtained by encoding information of color and the shape of the pixels of the image data reduced when the resolution conversion (reduction) process is applied to the image data. For example, in addition to image data equivalent to 300 dpi, the information of color and shape of the reduced pixels is held as the interpolation data if rendering is performed with 64 pixels×64 pixels equivalent to 600 dpi, and then the resolution is converted (reduced) to 32 pixels×32 pixels equivalent to 300 dpi. As a result, the amount of data during spooling can be reduced to the amount of data including the image data equivalent to 300 dpi and the interpolation data, while maintaining the reverse relationship with the image data equivalent to 600 dpi.

During output, such as a printing process, the interpolation data can be associated with the image data to develop the data to restore the colors and shapes of the pixels of the reduced image data when the resolution conversion (enlargement) process after spooling is executed.

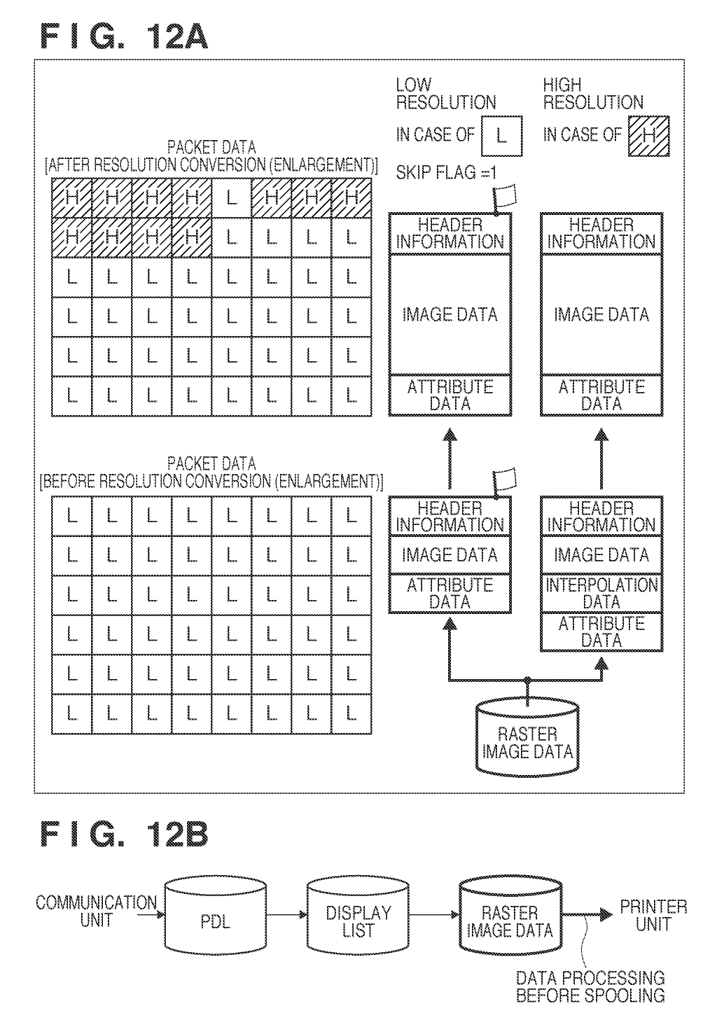

FIG. 12A is a diagram showing an example of packet data in the data processing after spooling corresponding to FIGS. 10A and 10B. FIG. 12B is a diagram showing a data flow of the data processing after spooling according to the present embodiment. The notations “H” and “L” in FIG. 12A are the same as the notations of FIG. 11A.

As shown in FIG. 12A, interpolation data is used to convert (enlarge) the resolution of the packet data corresponding to the tile image data A and B including vector image data among the packet data shown in FIGS. 10A and 10B to restore the high resolution of the image data.

Meanwhile, the original resolution of the image data is restored for the packet data corresponding to the tile image data C and D that do not include vector image data among the packet data shown in FIGS. 10A and 10B.

In other words, as shown in FIG. 11B, the packet data is transferred as indicated by two arrows relative to a data flow of one line when the raster image data is outputted to the printer unit in the data flow of the data processing before spooling. More specifically, the original resolution of the image data is restored for the packet data set with the skip flags by the resolution conversion (enlargement) without using the interpolation data.

Meanwhile, the interpolation data is used to convert (enlarge) the resolution to restore the high resolution of the image data for the packet data in which the skip flag is not set.

In this way, according to the present embodiment, not only the degradation of image quality of the raster image data can be prevented, but also the throughput of the block-by-block image processing can be improved when only the raster image data exists in the packet data.

Although three examples of block-by-block image processing (the rendering process, the resolution conversion (reduction) process, and the image compression process) are described, the mechanism of the block-by-block image processing in the present invention is not limited to this. For example, the advantages of the present invention can also be obtained by two block-by-block image processes (the rendering process and the resolution conversion (reduction) process, excluding the image compression process). The advantages of the present invention can also be similarly obtained in an example in which another block-by-block image process is added.

### Modified Example

A modified example of the present embodiment adopts different content of determination in S401 and further adopts a different condition of determination in S402. The description of the modified example overlaps the description of the present embodiment, except the additionally described content of S401 and S402. Therefore, the description will not be repeated.

Conventionally, there is a known technique of deleting a rendering object on the back side that is not rendered as the object is hidden behind a rendering object on the front side when a plurality of rendering objects overlap in the PDL extension process of S301. However, raster image data on the back side that is not rendered as the data is hidden behind the raster image data on the front side may not be able to be deleted when a plurality of raster image data overlap.

In view of the foregoing point, in relation to the content of determination in S401 of the modified example, the cases in which only raster image data, such as images, exist are further classified into cases in which the number of raster image data is smaller than a predetermined threshold and cases in which the number of raster image data is equal to or greater than the threshold. For example, if the threshold is set to 2, the skip flag is set for the condition of determination of S402 if there is a single raster image datum which is smaller than the threshold 2. On the other hand, the skip flag is reset for the condition of determination of S402 if there are a plurality of raster image data which are equal to or greater than the threshold 2, because an overlapping (composite) process is necessary.

According to the modified example, even if raster image data overlap, the throughput of the block-by-block image processing can be improved by separating the part with overlapped raster image data and the part without overlapping.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-296373, filed Dec. 25, 2009, which is hereby incorporated by reference herein in its entirety.

What is claimed is:

1. An image processing apparatus that divides inputted image data into blocks of a predetermined size and that applies a plurality of image processes to each block, the apparatus comprising:
a determination unit that determines whether a block includes image data with an attribute of not executing predetermined image processes when the plurality of image processes are executed; and
a control unit that does not apply the predetermined image processes to the block if said determination unit determines that the block includes the image data with the attribute of not executing the predetermined image processes and that applies the predetermined image processes to the block if said determination unit determines that the block does not include the image data with the attribute of not executing the predetermined image processes, wherein
the image data with the attribute of not executing the predetermined image processes is vector image data, and the predetermined image processes are rendering, resolution conversion, and image compression.

2. The apparatus according to claim 1, wherein
the image data with the attribute of not executing the predetermined image processes is image data not including vector image data or image data in which the number of raster image data is smaller than a predetermined threshold.

3. A control method of an image processing apparatus that divides inputted image data into blocks of a predetermined size and that applies a plurality of image processes to each block, the method comprising:
determining whether a block includes image data with an attribute of not executing predetermined image processes when the plurality of image processes are executed; and
controlling not to apply the predetermined image processes to the block if it is determined in said determining that the block includes the image data with the attribute of not executing the predetermined image processes and to apply the predetermined image processes to the block if it is determined in said determining that the block does not include the image data with the attribute of not executing the predetermined image processes.

4. A program that is recorded in a computer-readable recording medium and that causes a computer to execute the control method of the image processing apparatus according to claim 3.
